(19) United States
(12) Patent Application Publication
(10) Pub. No.: US 2007/0252420 A1
(43) Pub. Date: Nov. 1, 2007

(54) AUTOMOTIVE POWER SEAT MOTOR ARRANGEMENT INCLUDING A MONOLITHIC FRAME

(75) Inventors: Duncan E. Dungey, Lansing, MI (US); Brian S. Palmer, Lansing, MI (US)

Correspondence Address: BAKER & DANIELS LLP;111 E. WAYNE STREET, SUITE 800, FORT WAYNE, IN, 46802, US

(73) Assignee: Fasco Industries, Inc., Eaton Rapids, MI (US)

(21) Appl. No.: 11/380,947

(22) Filed: May 1, 2006

(51) Int. Cl. B60N 2/02

(52) U.S. Cl. 297/330

(57) ABSTRACT

An automotive power seat arrangement includes an automobile passenger seat connected to an automobile body. A plurality of mechanisms engage the seat. Each of the mechanisms moves the seat relative to the body in a respective manner. Each of a plurality of motors drives a respective one of the mechanisms. A frame retains each of the motors in parallel, releasable, snap-lock engagement.

### BACKGROUND

1. Field of the Invention.

The present invention relates to automotive power seat systems and, more particularly, to motor assemblies for automotive power seat systems.

2. Description of the Related Art.

Motor systems including multiple motors are used in a variety of applications, including automotive systems, for adjustably moving an object in different directions. For example, multiple motors may be used in automotive power seat applications in order to move the entire seat in forward and rearward directions, and to move the front and rear of the seat independently in upward and downward directions. The power seat motors are typically placed together in a “multi-pack” type configuration just below the seat that they actuate.

In known versions of “multi-packs”, i.e., multiple motor packages, the motors are sandwiched between two plastic end frames. The two end frames may hold together all of the components needed to enable the multi-pack to meet requirements for electro-magnetic compatibility/radio frequency interference, performance, sound, and motor spacing. If a new application of the multi-pack has a different set of requirements, then a different set of end frames is typically required. It has also been observed that creating a packaging design can be very difficult due to requirements that the multi-pack occupy a limited amount of space.

Another problem is that if some portion of the multi-pack fails and troubleshooting is required, then the entire multi-pack must be disassembled. More particularly, an entire end frame must be removed, thereby exposing and releasing each of the motors in the multi-pack. It is possible that all motors of the multi-pack must be removed in order to replace one failed motor. These actions leave open the possibility of damaging motors that were in good working order before disassembly, or even damaging or destroying the entire multi-pack.

What is needed in the art is a multi-motor packaging system that can be serviced without disassembling, and possibly damaging, the entire packaging system.

### SUMMARY

The present invention provides an automotive power seat arrangement including a multi-motor packaging assembly in which individual motors may be independently removed and inserted. A monolithic frame includes snap-locking features that cooperate with snap-locking features on the motors such that each individual motor may be quickly and easily secured to and released from the frame. The frame may retain the motors in parallel relationship to each other. The frame may also include channels that retain wires that carry power and communication signals to and from the motors and their associated electronics.

The monolithic frame of the present invention offers flexibility by allowing the use of individual, current production motor segments that meet or are close to meeting current and new sets of application requirements without having to redesign the component connections. The overall assembly of the “multi-pack” is also less labor intensive due to the fact that new shell-to-end frame crimp tooling is not required. The frame allows the individual motor segments to slide and “snap” into place. Having individual motor segments enables removal of only the “problem” segment while leaving the other segments in place, thereby avoiding possible damage to non-problematic segments in the event that troubleshooting is required. Monolithic frame multi-packs can also be built modularly. All the components can be built into sub-assemblies. Current designs of multi-packs do not offer this feature, thereby adding to the labor intensiveness of manufacturing.

The invention comprises, in one form thereof, an automotive power seat arrangement including an automobile passenger seat connected to an automobile body. A plurality of mechanisms engage the seat. Each of the mechanisms moves the seat relative to the body in a respective manner. Each of a plurality of motors drives a respective one of the mechanisms. A frame retains each of the motors in parallel, releasable, snap-lock engagement.

The present invention comprises, in another form thereof, an automotive power seat motor assembly including a plurality of motors. Each of the motors includes a first snap-locking feature and actuates a passenger seat of an automobile in a different respective manner. A monolithic frame includes a plurality of second snap-locking features each cooperating with a respective one of the first snap-locking features such that the frame retains each of the motors, and each of the motors is independently releasable from the frame.

The present invention comprises, in yet another form thereof, an automotive power seat motor assembly including a plurality of motors. Each of the motors includes a first snap-locking feature and a ferrule defining a longitudinal axis. Each motor actuates a function of a passenger seat of an automobile. A frame includes a plurality of sockets. Each of the sockets retains a respective one of the motors. Each socket has a respective opening facing along the longitudinal axis and through which the respective motor may be inserted. Each socket has a respective second snap-locking feature cooperating with the first snap locking feature of the respective motor such that each of the motors may be independently locked into and independently released from the respective socket. At least one channel extends across the sockets in a direction substantially perpendicular to the longitudinal axes. A wire harness assembly includes a plurality of motor connectors each in electrical communication with a respective one of the motors via wires extending through the at least one channel of the frame.

An advantage of the present invention is that individual motors may be inserted into and removed from the frame without disturbing the other motors.

Another advantage is that the frame can accommodate different motor designs. Thus, a different pair of end frames does not need to be designed for each set of motors that are required for a particular application.

Yet another advantage is that the initial assembly of the motor assembly is less labor intensive because the motor shells do not need to be crimped to the end frame.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic view of one embodiment of an automotive power seat arrangement of the present invention;

FIG. 2 is a top perspective view of the motor assembly of the automotive power seat arrangement of FIG. 1;

FIG. 3 is a top perspective view of the frame and wire harness assembly of the motor assembly of FIG. 2, from a different angle than FIG. 2;

FIG. 4 is a cross-sectional view of the motor assembly of FIG. 2 taken along line 4-4; and

FIG. 5 is a fragmentary, perspective view of the snap-locking features of the motor and frame of the motor assembly of FIG. 2.

Corresponding reference characters indicate corresponding parts throughout the several views. Although the exemplifications set out herein illustrate embodiments of the invention, the embodiments disclosed below are not intended to be exhaustive or to be construed as limiting the scope of the invention to the precise forms disclosed.

### DETAILED DESCRIPTION

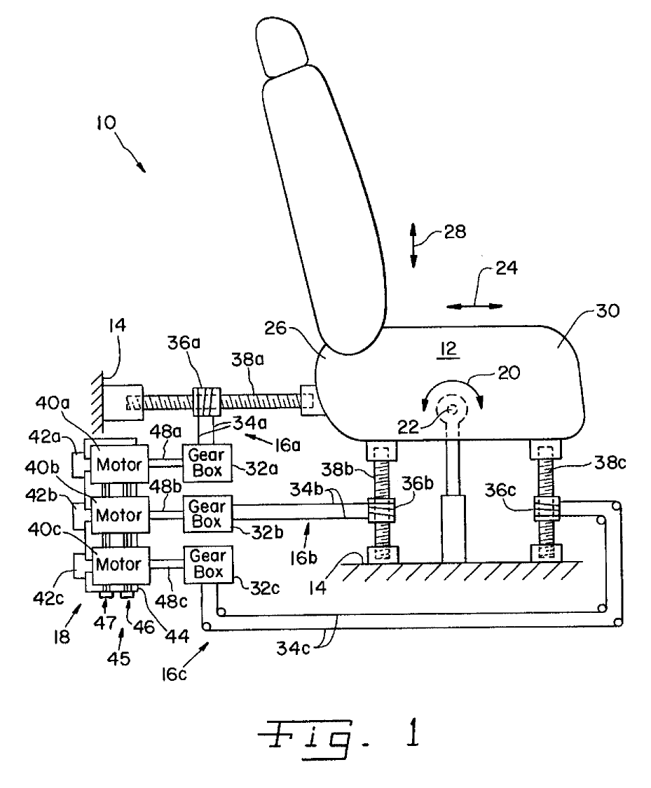

FIG. 1 illustrates one embodiment of an automotive power seat arrangement 10 of the present invention including an automobile passenger seat 12 connected to an automobile body 14, a plurality of mechanisms 16a-c, and a motor assembly 18. Seat 12 may be pivotable in directions indicated by double arrow 20 about a pivot 22. Seat 12 may be adjustably connected to body 14 via mechanism 16a such that seat 12 may be moved in forward and rearward directions indicated by double arrow 24. Seat 12 may also be adjustably connected to body 14 via mechanism 16b such that a rear portion 26 of seat 12 may be moved in upward and downward directions indicated by double arrow 28. Seat 12 may further be adjustably connected to body 14 via mechanism 16c such that a front portion 30 of seat 12 may be moved in upward and downward directions 28.

Mechanism 16a includes a gear box 32a driving a lead screw 34a that is capable of turning a nut 36a that is threadedly coupled to an adjustment shaft 38a. Ferrule 48a connects motor 40a to gear box 32a and houses a flex cable (not shown) which transmits driving force from the armature of motor 40a to gear box 32a which in turn then drives lead screw 34a. As lead screw 34a rotates, nut 36a rotates in one direction or the other about shaft 38a to thereby cause shaft 38a to move in one of the forward and rearward directions 24. Nut 36a may have a position that is fixed relative to directions 24. Shaft 38a may be rigidly attached to seat 12 such that forward and rearward movement of shaft 38a may cause corresponding forward and rearward movement of seat 12. Similarly, mechanism 16b includes a gear box 32b driving a lead screw 34b that is capable of turning a nut 36b that is threadedly coupled to an adjustment shaft 38b. Ferrule 48b connects motor 40b to gear box 32b and houses a flex cable (not shown) which transmits driving force from the armature of motor 40b to gear box 32b which in turn then drives lead screw 34b. As lead screw 34b rotates, nut 36b rotates in one direction or the other about shaft 38b to thereby cause shaft 38b to move in one of the upward and downward directions 28. Nut 36b may have a position that is fixed relative to directions 28. Shaft 38b may be rigidly attached to rear portion 26 of seat 12 such that upward and downward movement of shaft 38b may cause corresponding upward and downward movement of rear portion 26. The vertical position of front portion 30 of seat 12 may remain unchanged during the upward/downward movements of rear portion 26. Lastly, mechanism 16c includes a gear box 32c driving a lead screw 34c that is capable of turning a nut 36c that is threadedly coupled to an adjustable shaft 38c. Ferrule 48c connects motor 40c to gear box 32c and houses a flex cable (not shown) which transmits driving force from the armature of motor 40c to gear box 32c which in turn then drives lead screw 34c. As lead screw 34c rotates, nut 36c rotates in one direction or the other about shaft 38c to thereby cause shaft 38c to move in one of the upward and downward directions 28. Nut 36c may have a position that is fixed relative to directions 28. Shaft 38c may be rigidly attached to front portion 30 of seat 12 such that upward and downward movement of shaft 38c may cause corresponding upward and downward movement of front portion 30. The vertical position of rear portion 26 of seat 12 may remain unchanged during the upward/downward movements of front portion 30. Adjustment of mechanisms 16b and 16c facilitate pivoting of seat 12 about pivot 22 in the directions indicated by double arrow 20.

Motor assembly 18 includes motors 40a-c and optionally electronic rotational measurement devices 42a-c, all of which may be retained in a monolithic frame 44. Motor assembly 18 may also include a wire harness assembly 45 having a motor wire harness 46 and a rotational measurement wire harness 47. Motor wire harness 46 may be electrically connected to motors 40a-c, and rotational measurement wire harness 47 may be electrically connected to electronic rotational measurement devices 42a-c. Each of motors 40a-c includes a respective ferrule 48a-c for housing flex cables used to drive respective gear boxes 32a-c. Devices 42a-c may be in the form of potentiometers for measuring the rotational position and/or number of rotations of the respective motor from an initial reference position that may be established at the factory when motor assembly 18 is first manufactured. Devices 42a-c may be externally attached to motors 40a-c, externally positioned with respect to motors 40a-c (i.e., not actually attached to motors 40a-c), or internally attached within motors 40a-c. Devices 42a-c may include Hall Effect sensors and/or memory devices associated therewith.

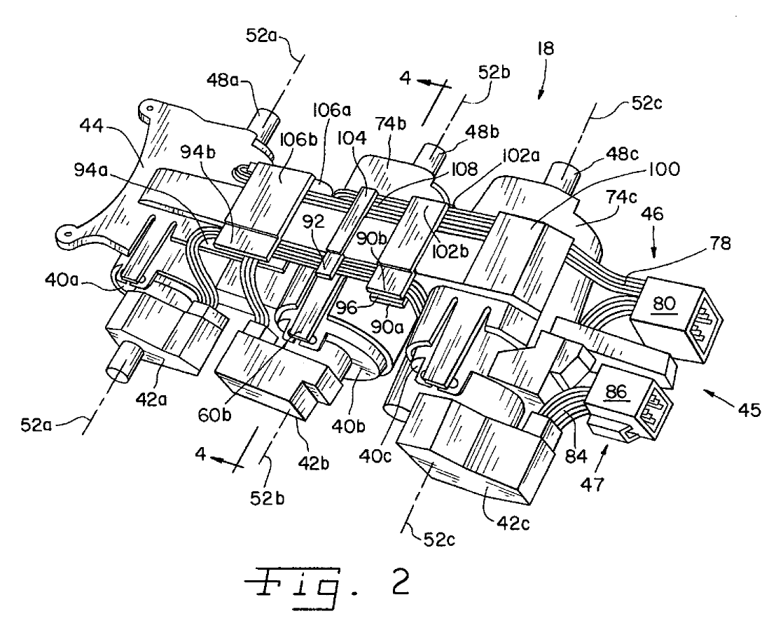

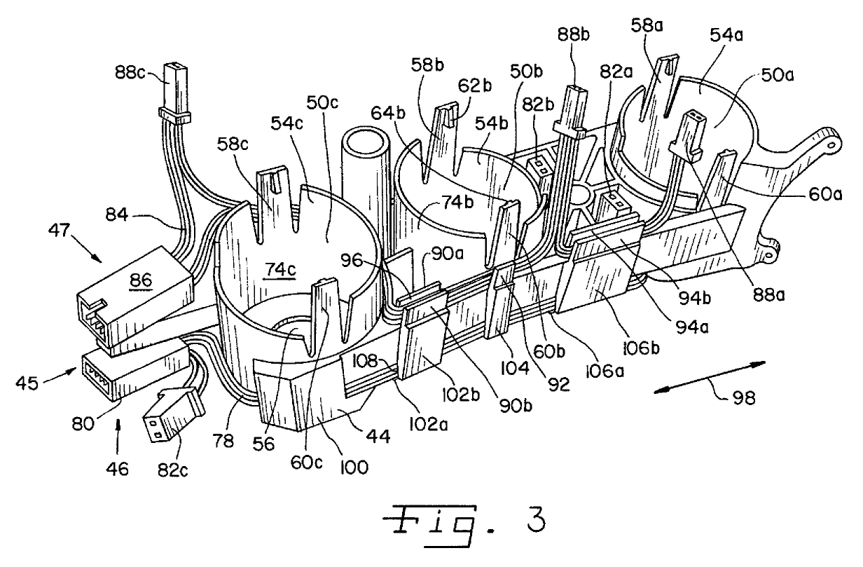

Automotive power seat motor assembly 18 is illustrated in more detail in FIG. 2. Frame 44 may be formed of a single, monolithic, i.e., unitary or integral, piece of semi-rigid or semi-flexible plastic, for example. As best shown in FIG. 3, frame 44 includes sockets 50a-c for retaining motors 40a-c, respectively. Sockets 50a-c may be oriented parallel to each other such that longitudinal axes 52a-c defined by ferrules 48a-c, respectively, are oriented parallel to each other when motors 40a-c are retained by frame 44. Each of sockets 50a-c has a respective one of openings 54a-c facing along a respective one of the longitudinal axes 52a-c. Each of motors 40a-c may be inserted into a respective one of sockets 50a-c through a respective one of openings 54a-c. Each socket 50a-c of frame 44 may include a respective ferrule passage 56 (FIG. 3) that is disposed opposite of a respective one of openings 50a-c. Only one ferrule passage 56, i.e., the ferrule passage 56 associated with socket 50c, is shown in FIG. 3 for ease of illustration. However, it is to be understood that sockets 50a and 50b also have ferrule passages 56 that may be substantially identical to passage 56 of socket 50c in terms of size, shape and placement. Each ferrule passage 56 may receive a respective one of ferrules 48a-c of motors 40a-c.

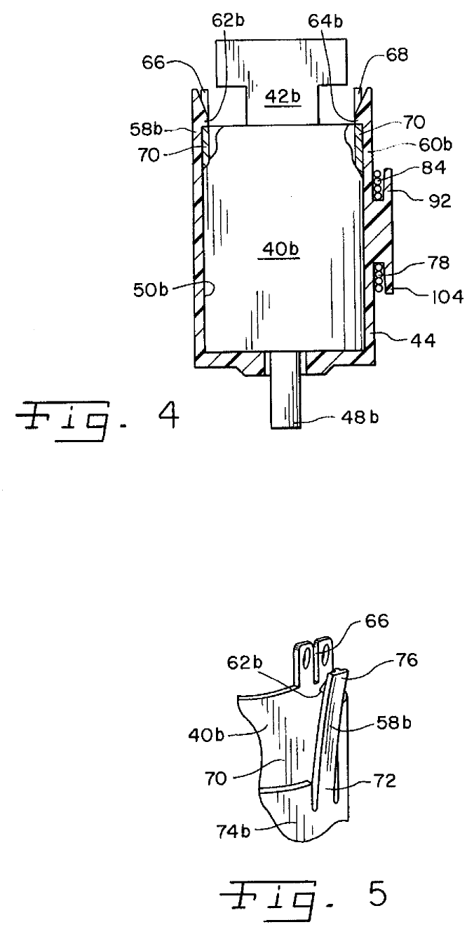

Each of sockets 50a-c may include a pair of opposing snap-locking features. More particularly, socket 50a includes cantilevers 58a, 60a, socket 50b includes cantilevers 58b, 60b, and socket 50c includes cantilevers 58c, 60c. All three pairs of cantilevers 58, 60 may be substantially identical, and thus only one pair, cantilevers 58b, 60b, will be described in detail herein. Cantilevers 58b, 60b have respective, vertically-oriented catches 62b, 64b that project or extend in radially inward directions, i.e., toward each other, as best shown in FIG. 4.

Motor 40b is shown in FIG. 4 as including its own pair of opposing snap-locking features in the form of vertically oriented slots 66, 68 that are cut into a steel housing 70 of motor 40b. Slots 66, 68 may cooperate with catches 62b, 64b to releasably lock motor 40b in socket 50b. FIG. 5 shows motor 40b just before being completely inserted into socket 50b, and hence just before catch 62b latches into slot 66. When motor 40b is fully inserted into socket 50b, catch 62b latches in vertical slot 66 of motor 40b to thereby lock motor 40b in socket 50b. Before motor 40b is fully inserted, however, as shown in FIG. 5, the side of motor housing 70 pushes cantilever 58b radially outward. Because frame 44 may be formed of a material that is at least semi-flexible, cantilever 58b may arch or bend radially outwardly while motor 40b is in the process of being inserted into socket 50b. In the flexed state, a proximal end 72 of cantilever 58b may be relatively unmoved because of its attachment to the body 74 of socket 50b. However, a distal end 76 of cantilever 58b may be flexed to the greatest extent in the radially outward direction. Upon motor 40b being fully inserted in socket 50b, cantilever 58b, no longer being outwardly biased by housing 70, springs back in a radially inward direction, thereby allowing catch 62b to fall into and latch into slot 66.

In order to remove a motor from an associated socket, cantilevers 58b, 60b may be simultaneously flexed in opposite radially outward directions, such as by a user's fingers or with the aid of tools such as screwdrivers, to thereby release catches 62b, 64b from slots 66, 68. After this disengagement of catches 62b, 64b from slots 66, 68, motor 40b is unlocked and may be pulled out of socket 50b.

Although the operation of one pair of cooperating snap-locking features is described above, it is to be understood that the description also applies to catch 64b and slot 68. Further, motors 40a, 40c include slots (not shown) that are substantially identical to slots 66, 68; and cantilevers 58a, 58c, 60a, 60c are substantially identical to cantilevers 58b, 60b. Thus, the structure and operation of the slots of motors 40a, 40c and of cantilevers 58a, 58c, 60a, 60c are not described in detail herein. Thus, the cooperating snap-locking features of motors 40a, 40b, 40c and of sockets 50a, 50b, 50c enable each of motors 40a, 40b, 40c to be independently locked into and independently released from respective sockets 50a, 50b, 50c.

Motor wire harness 46 includes a bundle of motor wires 78 attached to a main motor connector 80 and individual motor connectors 82a-c. Main motor connector 80 and individual motor connectors 82a-c may be electrically connected to brushes (not shown) of motors 40a-c via motor wires 78. Rotational measurement wire harness 47 includes a bundle of measurement wires 84 attached to a main measurement connector 86 and individual measurement connectors 88a-c. Main measurement connector 86 and individual measurement connectors 88a-c may be electrically connected to measurement devices 42a-c via measurement wires 84. As shown in FIGS. 2-3, frame 44 includes cantilevered walls 90a-b, 92, 94a-b which, along with cantilever 60b, define a channel 96. Channel 96 may be oriented, and may extend across sockets 50a-c, in directions 98 substantially perpendicular to longitudinal axes 52. Measurement wires 84 may be retained within channel 96.

Frame 44 includes cantilevered walls 100, 102a-b, 104, 106a-b which, along with socket bodies 74a-b, define a channel 108. Channel 108 may be oriented, and may extend across sockets 50a-c, in directions 98 substantially perpendicular to longitudinal axes 52. Channel 108 may be substantially parallel to channel 96. Motor wires 78 may be retained within channel 108.

As described above, channels 96, 108 may hold wires 84, 78, respectively, within frame 44 such that wires 78, 84 do not extend away from frame 44. If wires 78, 84 were otherwise free to hang loose away from frame 44, wires 78, 84 may be susceptible to getting snagged on surrounding objects, which could make installation of arrangement 10 difficult and possibly result in damage to wires 78, 84.

While this invention has been described as having an exemplary design, the present invention may be further modified within the spirit and scope of this disclosure. This application is therefore intended to cover any variations, uses, or adaptations of the invention using its general principles.

What is claimed is:

1. An automotive power seat arrangement comprising:
an automobile passenger seat configured to be connected to an automobile body;
a plurality of mechanisms engaging said seat, each of said mechanisms being configured to move said seat relative to said body in a respective manner;
a plurality of motors, each of said motors being configured to drive a respective one of said mechanisms; and
a frame retaining each of said motors in releasable, snap-lock engagement.

2. The arrangement of claim 1 wherein said frame is monolithic.

3. The arrangement of claim 1 wherein each of said motors includes a first snap-locking feature, said frame including a plurality of second snap-locking features, each of said second snap locking features cooperating with a respective one of said first snap-locking features such that said frame retains each of said motors in the releasable, snap-lock engagement.

4. The arrangement of claim 1 wherein each of said motors is independently releasable from said frame.

5. The arrangement of claim 1 wherein said frame includes a plurality of sockets, each of said sockets retaining a respective one of said motors.

6. The arrangement of claim 5 wherein each of said motors includes a ferrule defining a longitudinal axis, each said socket of said frame having a respective opening facing along the longitudinal axis and through which said respective motor may be inserted.

7. The arrangement of claim 5 wherein each of said motors may be independently locked into and independently released from a respective said socket.

8. The arrangement of claim 5 wherein each of said motors includes a longitudinal axis, said frame including a channel extending across said sockets in a direction substantially perpendicular to said longitudinal axes, said channel being configured to retain wires connected to at least one of said motors.

9. The arrangement of claim 1 wherein said frame retains said motors in parallel relationship.

10. An automotive power seat motor assembly comprising:
a plurality of motors, each of said motors including a first snap-locking feature and being configured to actuate a passenger seat of an automobile in a different respective manner; and
a monolithic frame including a plurality of second snap-locking features, each said second snap-locking feature resiliently movable with respect to each of said respective motors, each of said second snap-locking features cooperating with a respective one of said first snap-locking features such that:
said frame retains each of said motors; and
each of said motors is independently releasable from said frame.

11. The assembly of claim 10 wherein said frame includes a plurality of sockets, each of said sockets retaining a respective one of said motors.

12. The assembly of claim 11 wherein each of said motors includes a ferrule defining a longitudinal axis, each said socket of said frame having a respective opening facing along the longitudinal axis and through which said respective motor may be inserted.

13. The assembly of claim 12 wherein each said socket of said frame includes a ferrule passage opposite said opening, each said ferrule passage receiving a ferrule of a respective said motor.

14. The assembly of claim 11 wherein each of said motors may be independently locked into and independently released from a respective said socket.

15. The assembly of claim 11 wherein each of said motors includes a longitudinal axis, said frame including a channel extending across said sockets in a direction substantially perpendicular to said longitudinal axes, said channel being configured to retain wires connected to at least one of said motors.

16. An automotive power seat motor assembly comprising:
a plurality of motors, each of said motors including a first snap-locking feature and defining a longitudinal axis, each of said motors being configured to actuate a passenger seat of an automobile;
a frame including:
a plurality of sockets, each of said sockets retaining a respective one of said motors, each said socket having a respective opening facing along the longitudinal axis and through which said respective motor may be inserted, each said socket having a respective second snap-locking feature cooperating with said first snap locking feature of said respective motor such that each of said motors may be independently locked into and independently released from said respective socket; and
at least one channel extending across said sockets in a direction substantially perpendicular to said longitudinal axes; and
a wire harness assembly including a plurality of motor connectors each in electrical communication with a respective one of said motors via wires extending through said at least one channel of said frame.

17. The assembly of claim 16 wherein said frame is monolithic.

18. The assembly of claim 16 wherein said frame retains said motors in parallel relationship.

19. The assembly of claim 16 further comprising a plurality of electronic rotational measurement devices, each of said electronic rotational measurement devices being attached to a respective said motor and being configured to measure rotation of said respective motor, said wire harness assembly being in electrical communication with each of said electronic rotational measurement devices via said wires extending through said at least one channel of said frame.

20. The assembly of claim 19 wherein said wire harness assembly includes a plurality of measurement connectors each electrically connected to a respective one of said electronic rotational measurement devices.

21. The assembly of claim 19 wherein said electronic rotational measurement devices each comprise a potentiometer.
